(19) United States
(12) Patent Application Publication
(10) Pub. No.: US 2026/0155618 A1
(43) Pub. Date: Jun. 4, 2026

(54) QUAD AMPLIFIERS IN SINGLE QSFP FORM PACKAGE

(71) Applicant: II-VI Photonics, Inc., Fuzhou (CN)

(72) Inventors: Xiangfei WANG, Fuzhou (CN); Jun HAN, Shanghai (CN); Sijie CHEN, Fuzhou (CN); Dequan LIN, Fuzhou (CN)

(21) Appl. No.: 19/050,688

(22) Filed: Feb. 11, 2025

Related U.S. Application Data
(63) Continuation of application No. PCT/CN2024/135514, filed on Nov. 29, 2024.

(51) Int. Cl. H01S 3/091; H01S 3/00; H01S 3/067; H01S 3/0941; H01S 3/16; H01S 3/23

(52) U.S. Cl. CPC H01S 3/0912; H01S 3/0064; H01S 3/06708; H01S 3/0941; H01S 3/1608; H01S 3/2308

(57) ABSTRACT

Disclosed herein are optical amplifier devices, optical amplifier assembly, and optical amplifier systems. Example embodiments may include: a plurality of input optical ports, each being configured to receive one of a plurality of input optical signals; a plurality of output optical ports, each being configured to output one of a plurality of output optical signals; a plurality of tap photodiodes, each respectively being connected to one of the plurality of input optical ports and the plurality of output optical ports; a wavelength division multiplexer configured to receive the input optical signal from each of the plurality of input optical ports and an optical input from a laser pump device and output a plurality of pumped optical signals; a plurality of erbium-doped fiber coils, each having a first end configured to receive one of the plurality of pumped optical signals and a second end configured to output an amplified optical signal; and an optical isolator configured to receive, for each of the plurality of erbium-doped fiber coils, the amplified optical signal and output the plurality of output optical signals, wherein the plurality of output optical ports are configured to receive one of the plurality of output optical signals.

### CROSS-REFERENCE TO RELATED APPLICATIONS

The present application is a continuation of International Patent Application No. PCT/CN 2024/135514, filed Nov. 29, 2024. The aforementioned application is hereby incorporated by reference in its entirety.

The embodiments disclosed herein are in the field of optic communication devices used in optical systems. More particularly, the embodiments disclosed herein relate to optical amplifier devices used in optical communication devices and systems.

### BACKGROUND

Unless otherwise indicated herein, the materials described herein are not prior art to the claims in the present application and are not admitted to be prior art by inclusion in this section.

Existing optical communication devices use optical amplifier packaging to form daughter card amplifier assemblies in an inefficient configuration. Currently, pluggable optical amplifier assemblies implement a single optical amplifier in a four-lane Quad Small Form Factor Pluggable (QSFP) configuration or an increasingly popular Octal Small Form Factor Pluggable (OSFP) configuration. There are many kinds of applications of the existing switch/router slot to configure optical amplifiers; these slots may be used on carrier, data center interconnections, metro, long haul and in other applications. Further, some manufacturers can fit dual amplifiers into a QSFP, OSFP, or QSFP-DD form package. Due to the widespread nature of these form factors, improved optical communication devices in QSFP, OSFP, or QSFP-DD configurations are desired, particularly of devices implemented in optical electronic assemblies using multiple optical amplifiers. However, simply combining multiple individual optical amplifiers into the QSFP or OSFP or QSFP-DD configurations causes a severely inefficient use of limited packaging space. Accordingly, improved optical communication devices using multiple optical amplifiers in QSFP, OSFP, or QSFP-DD configurations in optical electronic assemblies, while limiting their increase in packaging size, is desired.

The subject matter claimed herein is not limited to implementations that solve any disadvantages or that operate only in environments such as those described above. Rather, this background is only provided to illustrate one example technology area where some implementations described herein may be practiced.

These and other advantages of the present invention will become more fully apparent from the detailed description of the invention herein below.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Embodiments are directed to an optical amplifier device, optical amplifier assembly, and system implementing an optical amplifier assembly. In one general aspect, optical amplifier devices may include a plurality of input optical ports, each being configured to receive one of a plurality of input optical signals. Optical amplifier devices may also include a plurality of output optical ports, each being configured to output one of a plurality of output optical signals. Disclosed devices may furthermore include a plurality of tap photodiodes, each respectively being connected to one of the plurality of input optical ports and the plurality of output optical ports. Disclosed devices may in addition include a wavelength division multiplexer configured to (i) receive the input optical signal from each of the plurality of input optical ports and an optical input from a laser pump device and (ii) output a plurality of pumped optical signals. Disclosed devices may moreover include a plurality of erbium-doped fiber coils, each having a first end configured to receive one of the plurality of pumped optical signals and a second end configured to output an amplified optical signal. Disclosed devices may also include an optical isolator configured to (i) receive, for each of the plurality of erbium-doped fiber coils, the amplified optical signal and (ii) output the plurality of output optical signals. Disclosed devices may furthermore include where the plurality of output optical ports are configured to receive one of the plurality of output optical signals.

In another aspect of the disclosure, implementations may include one or more of the following features. Optical amplifier devices where the plurality of input optical ports are combined in a first optical connector and the plurality of output optical ports are combined in a second optical connector. Optical amplifier devices where the optical isolator may include a hybrid optical component having the optical isolator and a gain flattening filter. Optical amplifier devices where the optical isolator and the plurality of tap photodiodes connected to the plurality of output optical ports may include an integrated hybrid optical component configured to receive the amplified optical signal and output the plurality of output optical signals. Optical amplifier devices where the plurality of tap photodiodes connected to the plurality of input optical ports may include a first tap photodiode assembly configured to receive the plurality of input optical signals received by the plurality of input optical ports. Optical amplifier devices where the plurality of tap photodiodes connected to the plurality of output optical ports may include a second tap photodiode assembly configured to receive the plurality of output optical signals. Optical amplifier devices where the laser pump device may include one of a dual-core laser pump and a quad-core laser pump. Optical amplifier devices where the plurality of erbium-doped fiber coils are configured individually to be excluded from a grouped assembly. In another aspect, disclosed herein are optical amplifier systems. In one aspect, optical amplifier systems where, for the more than one of the optical amplifier device, each of the plurality of input optical ports are combined in a first optical connector and each of the plurality of output optical ports are combined in a second optical connector.

In one general aspect, optical amplifier systems may include a plurality of input optical ports, each being configured in a first optical connector to receive one of a plurality of input optical signals. Optical amplifier systems may also include a plurality of output optical ports, each being configured in a second optical connector to output one of a plurality of output optical signals. Disclosed optical amplifier systems may furthermore include a plurality of first tap photodiodes, each being connected to one of the plurality of input optical ports. Disclosed optical amplifier systems may in addition include a wavelength division multiplexer configured to (i) receive the plurality of input optical signals from each of the plurality of input optical ports and an optical input from a laser pump device and (ii) output a plurality of pumped optical signals. Disclosed optical amplifier systems may moreover include a plurality of erbium-doped fiber coils, each having a first end configured to receive one of the plurality of pumped optical signals and a second end configured to output one of a plurality of amplified optical signals. Disclosed optical amplifier systems may also include a plurality of optical isolators, each configured to (i) receive the plurality of amplified optical signal and (ii) output the plurality of output optical signals. Disclosed optical amplifier systems may furthermore include a second plurality of tap photodiodes, each of the second plurality of tap photodiodes being connected to one of the plurality of output optical ports. Other embodiments of this aspect include corresponding computer systems, apparatus, and computer programs recorded on one or more computer storage devices, each configured to perform the actions of the methods.

Disclosed implementations may further include one or more of the following features. Optical amplifier systems where each of the plurality of optical isolators is configured in a third assembly to receive the plurality of amplified optical signals and output the plurality of output optical signals. Optical amplifier systems where each of the plurality of optical isolators may include a hybrid optical component assembly having the plurality of optical isolators and a plurality of gain flattening filters. Optical amplifier systems where each of the plurality of optical isolators may include a hybrid optical component assembly having the plurality of optical isolators and the second plurality of tap photodiodes. Optical amplifier systems where the plurality of erbium-doped fiber coils are configured individually to be excluded from a grouped assembly. Optical amplifier systems where the laser pump device may include a quad-core laser pump.

In one general aspect, optical amplifier assemblies may include a first optical connector having a plurality of input optical ports, each being configured to receive one of a plurality of input optical signals. Optical amplifier assemblies may also include a second connector having a plurality of output optical ports, each being configured to output one of a plurality of output optical signals. Optical amplifier assemblies may furthermore include a first tap photodiode assembly having a plurality of first tap photodiodes, each being connected to one of the plurality of input optical ports. Optical amplifier assemblies may in addition include a wavelength division multiplexer configured to (i) receive the plurality of input optical signals from each of the plurality of input optical ports and an optical input from a laser pump device and (ii) output a plurality of pumped optical signals. Optical amplifier assemblies may moreover include a plurality of erbium-doped fiber coils, each having a first end configured to receive one of the plurality of pumped optical signals and a second end configured to output one of a plurality of amplified optical signals. Optical amplifier assemblies may also include an optical isolator assembly having a plurality of optical isolators, each configured to (i) receive the plurality of amplified optical signal and (ii) output the plurality of output optical signals. Optical amplifier assemblies may furthermore include a second tap photodiode assembly having a plurality of second tap photodiodes, each being connected to one of the plurality of output optical ports.

Optical amplifier assembly implementations may include one or more of the following features. Optical amplifier assemblies where the plurality of erbium-doped fiber coils are configured individually to be excluded from a grouped assembly. Optical amplifier assemblies where the laser pump device may include a quad-core laser pump. Optical amplifier assemblies where one of: the optical isolator assembly may include a hybrid optical component assembly having the plurality of optical isolators and a plurality of gain flattening filters; and the optical isolator assembly and the second tap photodiode assembly may include a hybrid optical component assembly having the plurality of optical isolators and the plurality of second tap photodiodes.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a schematic diagram illustrating an exemplary optical amplifier device;

FIG. 1B is a schematic diagram illustrating an exemplary IWDM;

FIG. 1C is a schematic diagram illustrating an exemplary Tap PD design;

FIG. 2A is a schematic diagram illustrating another exemplary optical amplifier device with exemplary hybrid optical components;

FIG. 2B is a schematic diagram illustrating an exemplary IGFF 1 in 1;

FIG. 2C is a schematic diagram illustrating an exemplary IGFF 2 in 1;

FIG. 3A is a schematic diagram illustrating another exemplary optical amplifier device with other exemplary hybrid optical components;

FIG. 3B is a cross-sectional view of the fiber tip;

FIG. 3C is a schematic diagram illustrating an exemplary 1 in 1 isolator design;

FIG. 3D is a schematic diagram illustrating an exemplary 2 in 1 isolator design;

FIG. 3E is a schematic diagram illustrating an exemplary 4 in 1 isolator design;

FIG. 3F is a schematic diagram illustrating an exemplary 1 in 1 IWDM design;

FIG. 3G is a schematic diagram illustrating an exemplary 2 in 1 IWDM design;

FIG. 3H is a schematic diagram illustrating an exemplary 4 in 1 IWDM design;

FIG. 4 is a schematic diagram illustrating another exemplary optical amplifier device with other exemplary hybrid optical components;

FIG. 5A is a schematic diagram illustrating another exemplary optical amplifier device;

FIG. 5B is a schematic diagram illustrating an exemplary 4 in 1 Tap PD array design;

FIG. 6 is a schematic diagram illustrating another exemplary optical amplifier device with exemplary hybrid optical components; and

FIG. 7 is a schematic diagram illustrating another exemplary optical amplifier device with other exemplary hybrid optical components.

### DETAILED DESCRIPTION

It is to be understood that the figures and descriptions of the present invention may have been simplified to illustrate elements that are relevant for a clear understanding of the present embodiments, while eliminating, for purposes of clarity, other elements found in an optical amplifier device, optical amplifier assembly, and system using an optical amplifier device. Those of ordinary skill in the art will recognize that other elements may be desirable and/or required in order to implement the present embodiments. However, because such elements are well known in the art, and because they do not facilitate a better understanding of the present embodiments, a discussion of such elements is not provided herein. It is also to be understood that the drawings included herewith only provide diagrammatic representations of the presently preferred structures of the present invention and that structures falling within the scope of the present embodiments may include structures different than those shown in the drawings. Reference will now be made to the drawings wherein like structures are provided with like reference designations.

Throughout this description, when referring to the dimensions of electrical components, an orientation of Length×Width×Height is used unless otherwise specified.

As noted previously, the packaging configuration of existing optical amplifier devices is inefficient. In general, implementing multiple optical amplifier devices in QSFP or OSFP or QSFP-DD packaging configurations is limited by the existing optical components size in the market. However, it is advantageous, for example in data center, cloud, long haul communication, or telecom applications to increase density within one form package. Disclosed herein are embodiments that incorporate a plurality of amplifiers into disclosed package configurations. To increase the density of components within a fixed form factor, a key factor is the total volume of all the optical components and the fibers. Accordingly, disclosed herein are embodiments in which the inclusion and configuration of optical components provide for increased density, i.e., less total volume of all optical components for a given functionality.

Accordingly, the implementation of multiple optical amplifier devices in standard package configuration, e.g., QSFP, OSFP, or QSFP-DD packaging configurations, requires reducing the size of individual components and/or employing hybrid optical components/arrangements having a reduced overall size that has not otherwise been yet achievable. In some implementations, these hybrid optical components include passive optical elements.

Whether to use integrated optics or separate optics depends primarily on the overall volume of the device required to achieve the same optical function. For example, in the more advanced designs available, two erbium-doped fiber amplifiers (“EDFAs”) can be fitted into a single QSFP package using a Tap PD with a diameter of 1.8 mm and a length of 14 mm. This usage of two EDFAs corresponds to four Tap PDs, and each EDFA has one input Tap PD and one output Tap PD.

Another component that enables this reduction in size, and thus the fit of 4 EDFAs into a QSFP, is the pump laser. The single-channel pump laser may be implemented as a dual-channel pump laser, without changing the size of the design. In this way, the total volume of the pump laser remains the same while the density is doubled.

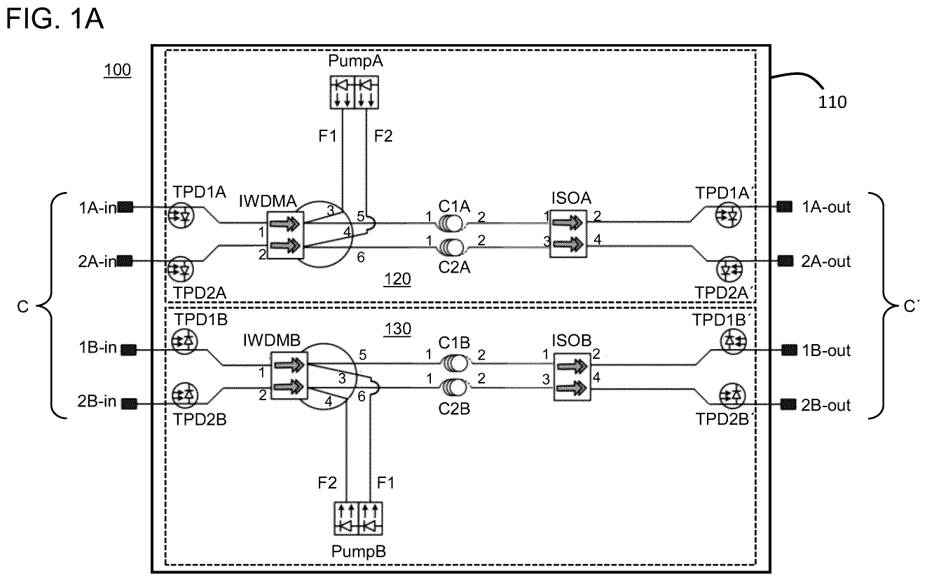

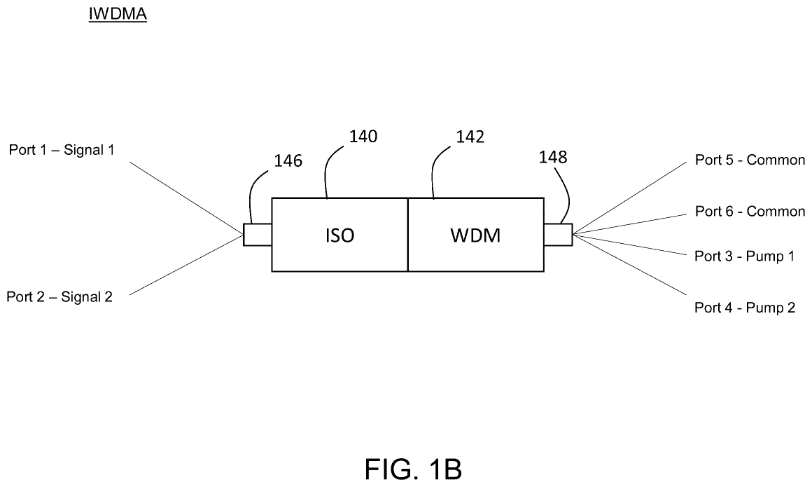

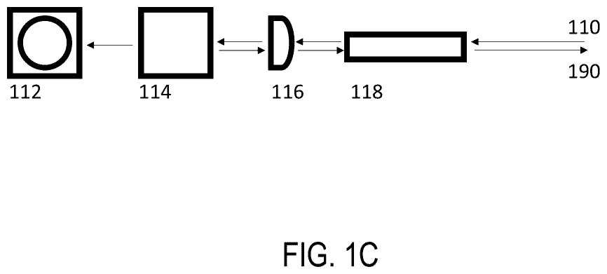

FIG. 1A is a schematic diagram illustrating an exemplary optical amplifier device 100. In FIG. 1A, the optical amplifier device 100 includes a pair of dual-amplifiers in a single packaging configuration, the individual components of which will be discussed below. For example, optical amplifier device 100 may be implemented in the single packing configuration as a QSFP, in which the optical amplifier device 100 includes a plurality of dual-amplifier pairs, for example, such as a first amplifier configuration 120 having a pair of dual-amplifiers and a second amplifier configuration 130 having a pair of dual-amplifiers, in which the first amplifier configuration 120 and the second amplifier configuration 130 have similar components. Here, the term dual-amplifier refers to implementing both a Boost Amplifier (“BA”) and a Pre-Amplifier (“PA”). Alternatively, a dual amplifier may be functional as both a two BA or two PA configuration. In some implementations, a line amplifier (“LA”) may also be used. That means up to four amplifiers can be fit into a QSFP package. These amplifiers may, for example, be comprised of four of the same amplifier type (i.e., four BA, four PA, four LA) or any combination thereof (i.e., two BA plus two PA). The four amplifiers may function independent of one another. For purposes of discussion, elements of the first amplifier configuration 120 are described below, and it is understood that the second amplifier configuration 130 includes these similar elements having similar designations, although as discussed above the amplifier types may be adjusted. Additionally, descriptions of a connection denote an optical connection using an optical waveguide, optical fiber, or the like, unless otherwise described.

In FIG. 1A, the individual optical components are mounted within a housing 110, including a printed circuit board assembly (“PCBA”). This PCBA (not shown) is for positioning and electrically connecting the described components and/or for arranging the described components for optical alignment even if not optically connected. The position of the PCBA in the housing, may comply, for example, with the QSFP+4× Hardware and Electrical Specification, SFF-8679 (Revision 1.8), Oct. 4, 2018, as published by SNIA, which is incorporated by referenced herein in its entirety. The optical components may be mounted on the bottom side of the PCBA or on the top side of the PCBA or on the bottom side of the housing or on the top side of the housing (still within the housing). Control hardware (i.e. EDFA control hardware) may be designed into and included on the PCBA. The tap photodiodes (discussed below) and pumps may have pins which are soldered onto PCBA for electrical signal connection. The PCBA may further include a power supply (not shown), and one or more controllers (such as microcontrollers or field programmable gate arrays) to control, for example, the photodiode(s) and pump(s).

In FIG. 1A, the optical arrangement of the first amplifier configuration 120 includes input optical ports 1A-in and 2A-in, output optical ports 1A-out and 2A-out, tap photodiodes TPD1A, TPD2A, TPD1A′, and TPD2A′, an isolated wavelength division multiplexer (“IWDM”) “A” (“IWDMA”), optical isolators ISOA, erbium-doped fiber coils C1A and C2A, and a dual-core pump PumpA. The input optical port 1A-in is connected to input 1 of the IWDMA, in which tap photodiode TPD1A detects a power of an optical signal supplied to the input optical port 1A-in. Similarly, the input optical port 2A-in is connected to input 2 of the IWDMA, in which tap photodiode TPD2A detects a power of an optical signal supplied to the input optical port 2A-in.

At IWDMA, the signals provided at the input optical ports 1A-in and 2A-in, are optically connected as inputs to the IWDMA, in which each of the input signals is combined with energy provided by the PumpA—this pump energy is provided along Fibers 1 (“F1”) and 2 (“F2”) to input ports 3 and 4 of the IWDMA. The pumped input signals are then provided at outputs 5 and 6 as multiplexed outputs of the IWDMA. The multiplexed outputs are then optically connected to erbium-doped fiber coils C1A and C2A, which in-turn amplify the multiplexed, pumped signals to produce amplified input signals at outputs 2 of the erbium-doped fiber coils C1A and C2A.

Next, the amplified signals produced by the erbium-doped fiber coils C1A and C2A are optically input to the optical isolator ISOA at inputs 1 and 3, respectively. The optical isolator ISOA prevents back reflections or signals that may occur downstream of the optical isolator ISOA from damaging a laser source or causing the laser source to mode hop, modulate amplitude, or frequency shift. The amplified signals are produced at outputs 2 and 4 of the ISOA, and provided as outputs to optical port 1A-out and 2A-out. Intermediate tap photodiodes TPD1A′ and TPD2A′ detect a power of the amplified signals being provided to the output optical ports 1A-out and 2A-out, respectively.

In FIG. 1A, the IWDMA may comprise a 2-in-1 IWDM (such as the one as shown in FIG. 1B) and the dual-core pump PumpA may comprise a 3-pin dual-core uncooled pump, for example similar to that of model MLU96Z***−7* (Ultra-compact, Micro-format Uncooled 980 nm Pump Laser Diode Module, the data sheet for which is disclosed herewith1 and is herein incorporated by reference in its entirety) supplied by Coherent which aids in reduction of pump package size and power consumption by omitting a thermoelectric cooler. The 3-pin connection may provide electrical contact to the PCBA, which may include separate power supply (positive) pins for each pump of the dual-core pump and a shared reference (negative) pin, or a shared positive pin, for example similar to the DMU 98-Series High Performance Ultra-Compact Uncooled 980 nm Dual-Chip Pump Laser Diode Module and supplied by Coherent. The input optical ports 1A-in and 2A-in may comprise an optical/mechanical connector C and the output optical ports 1A-out and 2A-out may also comprise an optical/mechanical connector C′, either the same or different from the optical/mechanical connector C of the input optical ports 1A-in and 2A-in. 1 Available at the time of disclosure at: https://www.coherent.com/content/dam/coherent/site/en/resources/datasheet/networking/micro-format-uncooled-980 nm-pump-laser-diode-module-mlu96z-7-ds.pdf

In the optical amplifier device 100, the IWDMA, optical isolator ISOA, and tap photodiodes TPD1A, TPD2A, TPD1A′, and TPD2A′ may comprise separate individual components or joint dual packages. For example, while the IWDMA may comprise a dual package configuration, the tap photodiodes TPD1A, TPD2A, TPD1A′, and TPD2A′ may comprise separate individual components. The IWDMA is a hybrid component, in that it provides the function of two isolators and two WDMs together, enabling a more streamlined and efficient configuration. A traditional individual isolator includes an isolator core, an input collimator, and an output collimator. Further a traditional wavelength division multiplexer (WDM) includes a WDM filter, an input collimator, and an output collimator. To provide the function of two isolators and two WDMs (four components) using traditional components, one would need four input collimators and full output collimators, two isolator cores, and two WDM filters. The hybrid IWDMA (a package configuration of these components) reduces the component complexity, and reduces the footprint of the total device by three input collimators, three output collimators, one isolator core and one WDM filter; the dual isolator and WDM function of IWDMA may share one input collimator and one output collimator, two isolators may share one isolator core, and two WDMs may share one WDM filter. Disclosed IWDMs, e.g., IWDMA, may have a similar structure as the IWDM of co-pending U.S. application Ser. No. 18/121,406 (US 2024/0291224), which is herein incorporated by reference in its entirety. Accordingly, the first amplifier configuration 120 can reduce size and material cost significantly compared to the use of an individual isolator and WDM. However, in some situations the use of individual components, for example TPD1A and TPD2A, may allow for an easier assembly process than the use of joint or hybrid components. For example, an individual TPD diameter is about 1.0 mm with a length of 10 mm, while a 2 in 1 Tap PD size is about 10 mm×1.6 mm×1.8 mm, so depending on the arrangement of individual components, individual TPDs may be easier to mount and locate among other, e.g., bulkier, components because of their smaller individual size with the tradeoff of occupying additional total area PCBA as compared to hybrid components.

FIG. 1B shows an example detailed schematic view of an IWDMA, like that shown in FIG. 1A, with the same input and out ports numbered in FIG. 1. The example IWDMA includes an isolator 140, wavelength division multiplexer 142, and input and output collimators 146, 148. 146 input collimator is a two fiber pigtail (two fibers insert into one pigtail); 148 output collimator is a four fiber pigtail (four fibers insert into one pigtail) . The IWDMA (two optical channels) as shown may share one isolator, and one wavelength division multiplexer. In this arrangement, a two fiber pigtail input/four fiber pigtail output can keep the same or similar size as single fiber pigtail.

FIG. 1C is a schematic illustration of an example Tap PD design, for example, TPD1A, TPD2A, TPD1B, or TPD2B of FIG. 1A. The illustrated embodiment comprising a PD die 112, an optical tap filter 114, a lens 116, and a pigtail 118. The Tap PD design may include an input 110 and output 190. For example, with respect to TPD1A of FIG. 1A, the input 110, the Tap PD, and input 110 may be optically connected to 1A-in and the output 190 may be optically connected to port 1 of the IWDMA. The Tap PD design allows for the size of key optical components (i.e., tap filter, lens, pigtail, glass tube, etc.) to be reduced, therefore allowing the size of the entire device to be reduced. For example, in one embodiment, the size of the PD die is about 100 μm, and therefore may be packaged compactly. In one embodiment, the dimensions of the Tap PD is 1.0 mm×10 mm (Diameter×Length). Therefore, the size of the key optical device is reduced, and its minimum may be limited by manual assembly. In one embodiment, the size of the lens 116 and pigtail 118 may be limited to a diameter of less than about 0.7 mm. In another embodiment using mechanical assembly (e.g., coupling a fiber to a PD die with a mechanical mount to hold the fiber), this limit may be reduced to about 0.5 mm or less in diameter. In one example, a pigtail assembly is inserted into a glass capillary by hand, which may limit the minimum practical size of the pigtails. Currently the practical minimum size according to hand assembly is about 0.7 mm diameter to make a 1.0 mm diameter tap PD. In one example, the pigtail, lens, and tap filter are assembled inside a tube, e.g., a glass tube or a metal tube, to house them.

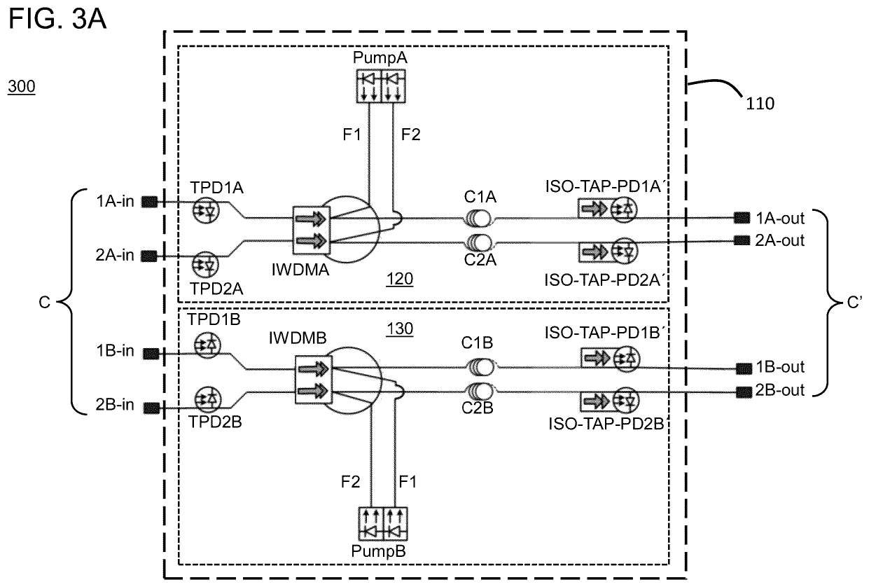

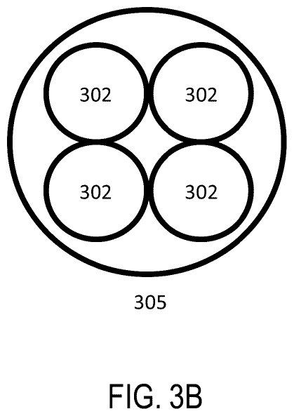

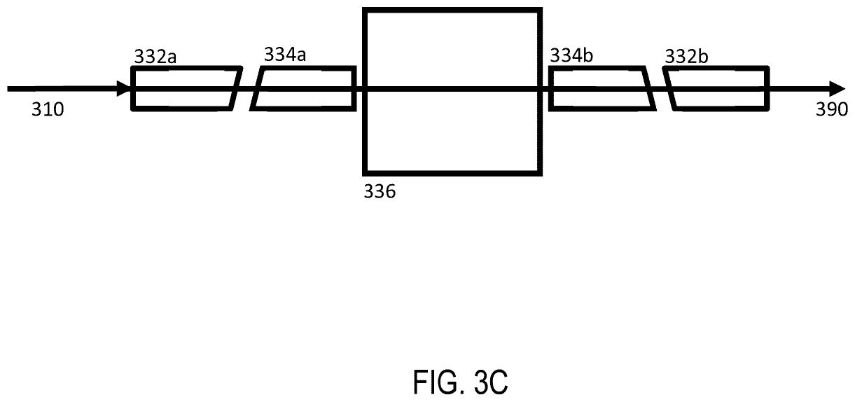

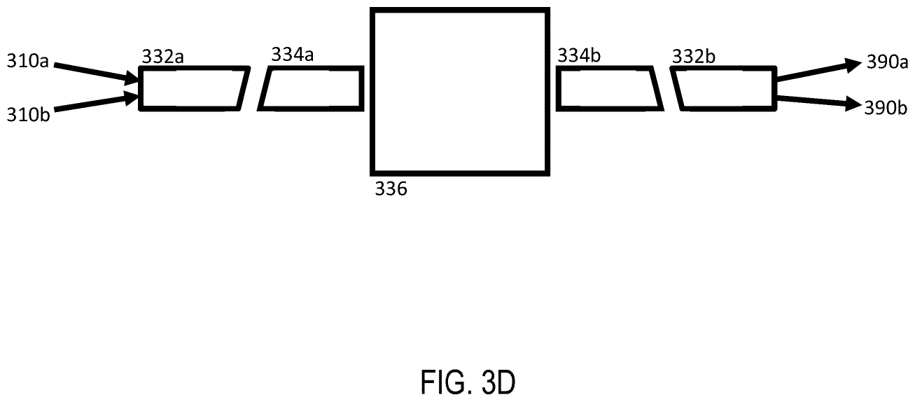

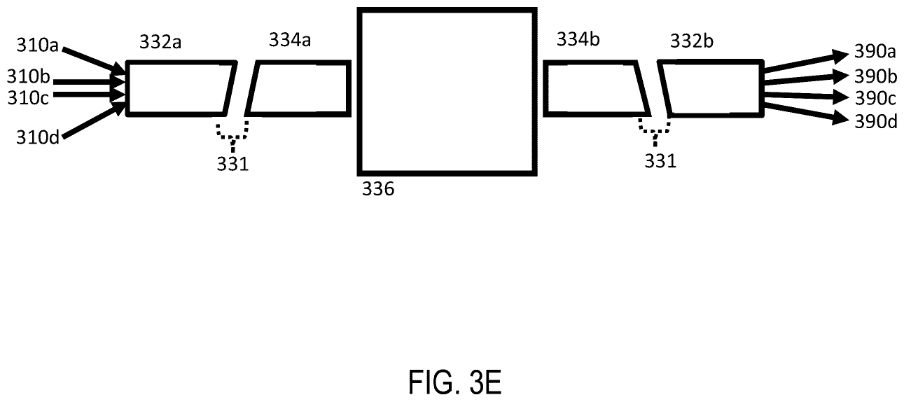

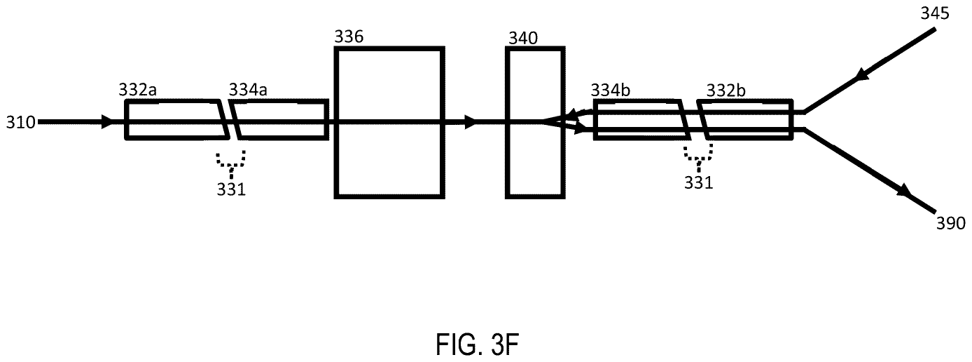

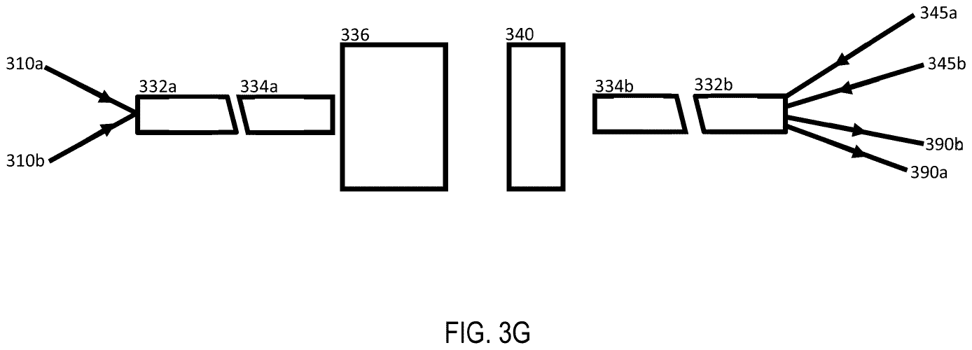

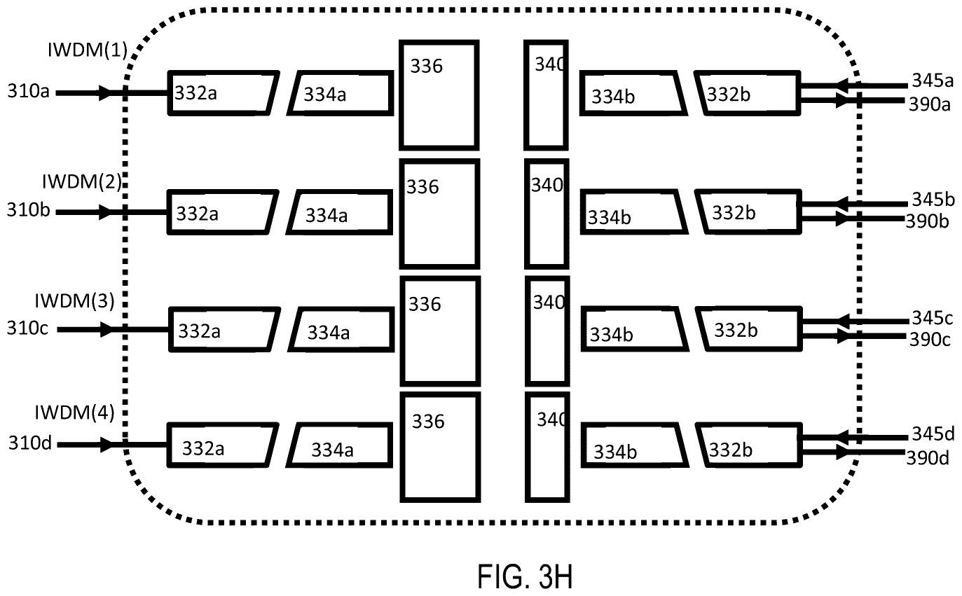

Referring back to FIG. 1A, similarly to the IWDMA, the ISOA is a joint package, including two isolators in one package. When compared to individual isolators, this may save one input collimator, one output collimator, and one core. As shown in FIG. 1A, the ISOA can share a single isolator's materials and package—due to it having two isolator optical paths—while still providing separate optical paths. TPD1A (as well as TPD1A′) in the first amplifier configuration 120, includes a tap filter and a photodiode (“PD”). The integration of this tap filter with the PD package significantly reduces the size compared to an individual PD and individual coupler. The use of hybrid IWDM (e.g., IWDMA and TPD1A) alongside other hybrid components (e.g., ISO-TAP-PD of FIG. 3) as discussed below, benefits the system by reducing the total length of interconnecting fiber used (and thus, reducing the volume of the device). The fiber length traditionally needed between any two components is often between about 60 cm and about 80 cm. This length may be required for fiber splicing, fiber recoating, etc. The combination of two components (i.e. an isolator and a WDM in an IWDMAN) can reduce or remove the fiber length needed between them. This reduction in fiber length (and therefore volume) further reduces the form factor of the device, contributing to fitting four EDFA and the remaining components into one QSFP package.

For the example optical amplifier device 100 using two EDFAs, and four Tap PDs, where the diameter of the Tap PD is the previously mentioned, advanced design of 1.8 mm in diameter and 14 mm in length, the volume of one tap PD would be approximately 35.61 mm³ and the volume of a device using 4 Tap PDs would be approximately 142.43mm³.

In FIG. 1A, the erbium-doped fiber coils C1A and C2A are provided individually, as are the tap photodiodes TPD1A, TPD2A, TPD1A′, and TPD2A′. In some implementations, the plurality of erbium-doped fiber coils C1A and C1B may be configured individually to be excluded from a grouped assembly. For example, a particular configuration may require different gain for each EDFA, and/or different pump power, which may result in a different suitable length for the erbium-doped fiber. Accordingly, the first amplifier configuration 120 implements two EDFAs (C1A/C2A) channels by separate control. This allows for each erbium-doped fiber coil (C1A and C2A) to be controlled separately with different input power, different output power, and different gain, while still obtaining the overall benefits of reduced package size of the first amplifier configuration 120.

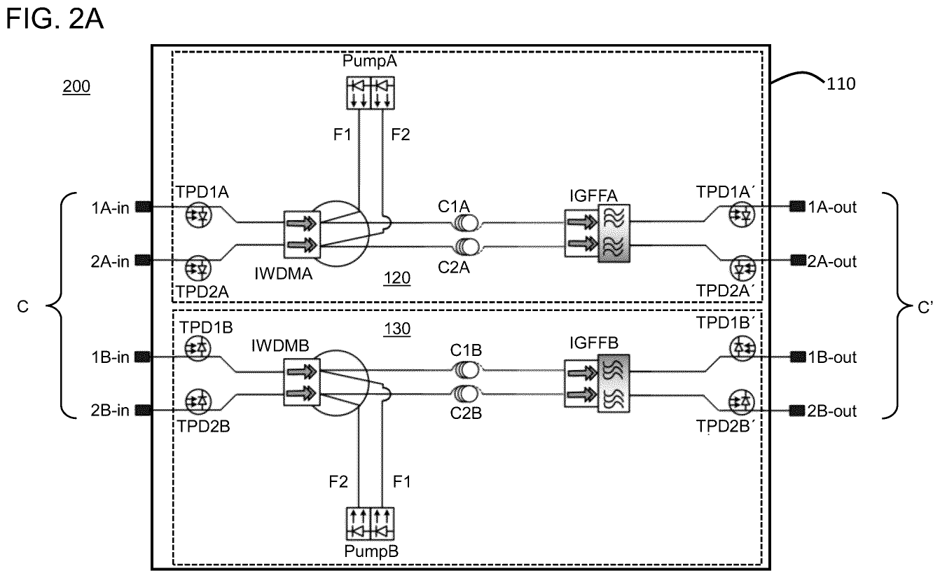

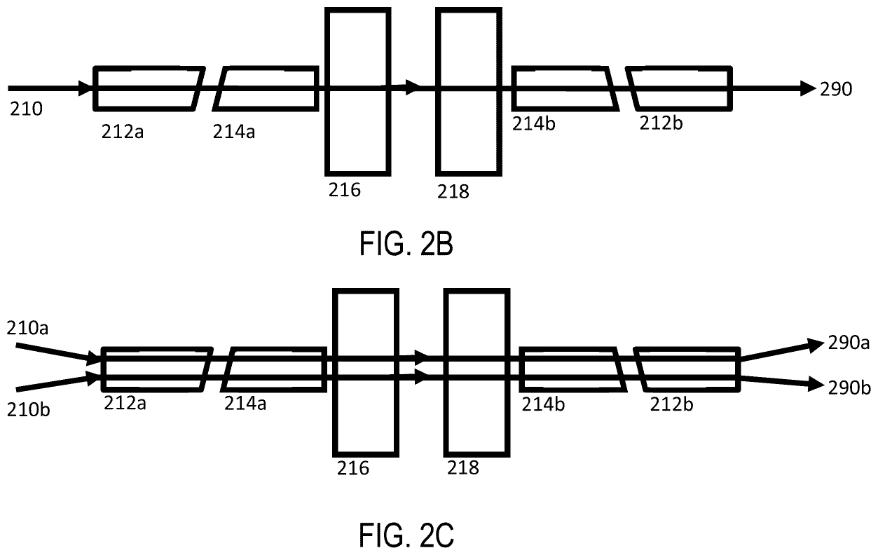

FIG. 2A is a schematic diagram illustrating another exemplary optical amplifier device with exemplary hybrid optical components. Similar to the device 100 depicted in FIG. 1 (and thus descriptions above similarly apply where applicable), the optical amplifier device 200 of FIG. 2A includes a pair of dual-amplifiers in a single packaging configuration. However, in FIG. 2, each of the 2-in-1 optical isolators ISOA and ISOB have been replaced with a hybrid optical component comprising an isolator gain flattening filter (“IGFF”) “A” (“IGFFA”) and “B” (“IGFFB”). In addition to providing the benefits of an optical isolator, as described above, implementing the IGFF improves gain flatness, suppresses amplifier spontaneous emission (ASE), and improves the performance of global optical signal to noise ratio (OSNR). OSNR values are expressions of signal degradations caused by ASE noise added from placing optical components (i.e., amplifiers) along the transmission link; OSNR is a key measure of signal quality in long distance fiber optic communications.

FIG. 2B and FIG. 2C are schematic diagrams illustrating exemplary IGFFs, with FIG. 2B depicting an IGFF “1 in 1” (or 1:1, one input to one output) with one input 210 and one output 290, and FIG. 2B depicting an IGFF “2 in 1” (or 2:2, two inputs to two output) with two inputs 210 a, 210b and two outputs 290a, 290b (like IFGGA or IGFFB in FIG. 2A). Both IGFFs have a similar optical signal chain, with the signal input at input 210 first traveling via a pigtail 212a and lens 214a combo, followed by an isolator core 216 and a “Gain Flatness Filter” (“GFF”) 218. After the core 216, the signal travels through another pigtail 214b and lens 212b combo before being output 290. The 2:2 can be similar to the 1:1 with losses of about 0.1 dB. Since the gain filter is the same, the gain flatness spectrum is the same. In one example, the 2:2 construction is using the same dual EDFA with same gain flatness design for each channel. For example, if the flat gain designed at 17 dB, a gain flattening filter only can ensure 17 dB gain is flat, with other gain ranges not being flat based on an EDFA peak gain around 1530 nm. However, the tradeoff provides for more compact overall components.

FIG. 3A is a schematic diagram illustrating another exemplary optical amplifier device with other exemplary hybrid optical components. The optical amplifier device 300 includes a pair of dual-amplifiers in a single packaging configuration—similar to the optical amplifier device 100 depicted in FIG. 1. However, in FIG. 3, the optical isolator ISOA and tap photodiodes TPD1A′ and TPD2A′ are replaced with hybrid optical components (ISO-TAP-PD1A′ and ISO-TAP-PD2A′) comprising an integrated isolator and tap photodiode. In one configuration of the optical amplifier device 100, the associated optical isolator ISOA and tap photodiodes TPD1A′ and TPD2A′ may include one 2 in 1 isolator, and two TPDA, which includes three components. However, with the development of components packaging technology, the integrated optical isolator and tap photodiodes (ISO-TAP-PD1A′ and ISO-TAP-PD2A′) may include an isolator core fit into a very small Tap PD such as 1.2 mm×1.2 mm×12 mm Tap PD without increased Tap PD (e.g. TPDA in 100) package size. The combination of isolator, tap filter, and PD can reduce or remove the fiber length needed between each component.

Compared to device 100, device 300 may have a decreased component count (e, g, two components of ISO-TAP-PD) to achieve similar functions. As noted, the ISO-TAP-PDs (ISO-TAP-PD1A′ and ISO-TAP-PD2A′) hybrids the function of an isolator, a tap filter, and a PD. This combination both reduces the materials and size, and reduces the fiber volume by eliminating connecting fibers between components. Thus, the overall size of the first amplifier configuration 120 is reduced compared to prior optical devices. Similar benefits are provided for the second amplifier configuration 130, whereby the overall size of the optoelectronic device 300 is comparatively reduced.

FIG. 3B is a cross-sectional view of an example fiber tip. The structure of the fiber tip—a “four-fiber pigtail” henceforth referred to as simply “pigtail”—may include four individual fibers 302 within a flared glass tube 305. Although FIG. 3B shows an example of four fibers, pigtails may also include less than or more than four fibers. This structure of fiber tip may be used in the pigtail component of the device components described herein to optically communicate a plurality of optical pathways with the number of fibers within the respective pigtail being delineated by the number of optical paths denoted schematically. The exterior tube 305 may be coated or affixed to a different material or itself comprised of a different inert material altogether.

FIG. 3C-FIG. 3E are schematic illustrations of example isolator designs, with FIG. 3C being a 1 in 1 isolator, FIG. 3D being a 2 in 1 isolator, and FIG. 3E being a 4 in 1 isolator. While this section will refer to “input” and “output” components relative to their position in the signal chain, in certain embodiments, these may be the same components. Each isolator example may include an input signal 310 optically communicated via an input pigtail 332a, an input lens 334a, and an isolator core 336, followed by an output lens 334b, and an output pigtail 332b to provide the output signal 390. In FIG. 3C—the 1 in 1 isolator—the single channel size is frequently 22 mm×2.0 mm (Diameter×Length). FIG. 3D shows an example the 2 in 1 isolator in which the number of inputs 310a, 310b, and outputs 390a, 390b is doubled without changing the components, doubling the density. In practice because the optical parts are large enough to separate the two optical beams within the parts, crosstalk of −50 db can be maintained.

FIG. 3E shows an example 4 in 1 isolator, where the number of inputs 310 a, 310 b, 310 c, 310d and outputs 390a, 390b, 390c, 390d is increased to four. Further, in one or more examples of the isolators of FIG. 3C-3E the interfaces 331 (shown in FIG. 3E) between the respective pigtail and lens (e.g., 332a/334a and 334b/332b) may be set at an angle, e.g., about 8° angle deviation from orthogonal with respect to a longitudinal axis of the respective pigtails to optimize optical path alignment—more specifically, to reduce return loss.

FIG. 3F-FIG. 3H are schematic illustrations of IWDM designs, with FIG. 3F being a 1 in 1 IWDM, FIG. 3G being a 2 in 1 IWDM (like those shown in FIGS. 1A and 1B), and FIG. 3H being a 4 in 1 IWDM. While this section will refer to “input” and “output” components relative to their position in the signal chain, in certain embodiments, these may be the same components. Each IWDM design includes an input signal 310 optically input through an input pigtail 332a, an input lens 334a, and an isolator core 336, followed by a WDM filter 340, an output lens 334b, and an output pigtail 332 b. The pigtails 332a/332b and lenes 334a and 334b may be respectively referred to as a “collimator” as a combined component. The output pigtail 332b has a port for a pump signal 345 (“pump port”) input and a port for the pumped output signal 390 (“common port”). Similar to above, the interfaces 331 (shown in FIG. 3F) between the respective pigtail and lens (e.g., 332a/334a and 334b/332b) may be set at an angle, e.g., about 8° angle deviation from orthogonal with respect to a longitudinal axis of the respective pigtails to optimize optical path alignment—more specifically, to reduce losses due to reflection.

In FIG. 3F—the 1 in 1 IWDM—for the illustrated embodiment, the input signal 310 may have, for example, a wavelength of about 1550 nm, and the output signal 390 at the common port may have a wavelength of about 980 nm. In one embodiment, the size of the 1 in 1 IWDM is 22 mm×2.2 mm (Length×Diameter).

In FIG. 3G—the 2 in 1 IWDM—the design includes first and second signal inputs 310a, 310b, first and second pump signals 345a, 345b, and first and second common port outputs 390a, 390b. In one embodiment, the IWDM design shares the same optical port for two channels, while the density of the fiber pigtail is doubled, resulting in a dual port fiber pigtail at one end and 4 fiber port pigtail at the other end. In one embodiment of the 2 in 1 IWDM, a pigtail using four fiber ports within a diameter of 2.2 mm is used, allowing the total size to remain 22 mm×2.2 mm (Length×Diameter), equivalent to the 1 in 1 IWDM device. In one embodiment, the optical crosstalk of the 2 in 1 IWDM is less than 50 dB, preventing mutual interference.

FIG. 3H schematically shows a 4 in 1 IWDM example, which includes 4 sets (IWDM(1), IWDM(2), IWDM(3), IWDM(4) of the previously discussed 1 in 1 IWDM components. Each set is comprised of an input signal 310 (310a, 310b, 310c, 310d) input through pigtail 332a, an input lens 334a, and an isolator core 336, followed by a WDM filter 340, an output lens 334b, and output through output pigtail 332b as outputs (390a, 390b, 390c, 390d). The pigtail 332b is also configured to receive pump signals 345 (345 a, 345 b, 345 c, 345 d). The pigtails 332a/332b and lenes 334a and 334b may be respectively referred to as a “collimator” as a combined component. Further, while the pigtails 332a and 332b are shown as four separate components, they may be combined, e.g., as a four-channel input pigtail 332a and/or as an eight-channel output pigtail 332b. In one embodiment, the dimensions of the 4 in 1 IWDM of FIG. 3H are 20mm×4.0 mm×1.5 mm.

Due to the presence of a reflection light path in the IWDM, encapsulating a 3 in 1 device (not shown), or the 4 in 1 device, in a QFSP form factor for common commercial passive components dimensions of 22 mm×2.2 mm (Length×Diameter), presents numerous difficulties—particularly, the light path is highly sensitive to debugging, creating difficulties in achieving crosstalk of 50 dB, balancing the multi-channel indicators, and causing degradation of the indicators over time. Additionally, encapsulating the 4 in 1 IWDM device may include 4 fiber ports in one pigtail at one end, and 8 fiber ports in at the other. One example, the disclosed IWDMs with a 22 mm×2.2 mm package interface with pigtails having about a 1.2 mm diameter.

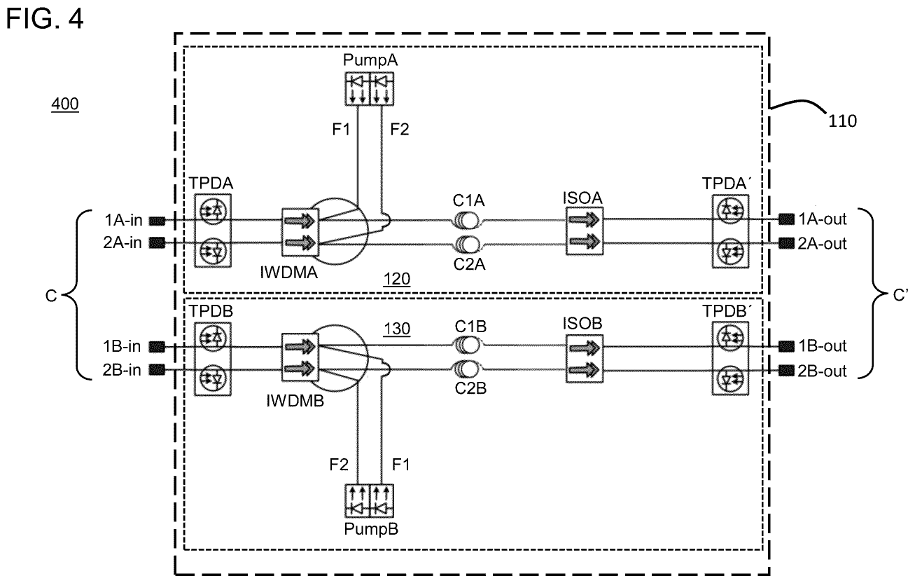

FIG. 4 is a schematic diagram illustrating another exemplary optical amplifier device 400 with exemplary hybrid optical components. Similar to the device 100 depicted in FIG. 1, the optical amplifier device 400 of FIG. 4 includes a pair of dual-amplifiers in a single packaging configuration. However, in FIG. 4, the tap photodiodes TPD1A and TPD2A are integrated into a hybrid optical component comprising a 2-in-1 tap photodiode assembly TPDA, and likewise the tap photodiodes TPD1A′ and TPD2A′ are integrated into a hybrid optical component comprising a 2-in-1 tap photodiode assembly TPDA′. Accordingly, tap ratios of the tap photodiodes TPD1A′ and TPD2A′ at the input optical ports 1A-in and 2A-in of the first amplifier configuration 120 may be substantially the same since the input power range of optical signals provided at the input optical ports 1A-in and 2A-in may be the same. Additionally, although not shown, the integrated 2-in-1 tap photodiode assembly TPDA may make use of sharing a tap ratio filter, thereby reducing an overall size of the first amplifier configuration 120. Similarly, a tap ratio at the output optical ports 1A-out and 2A-out of the first amplifier configuration 120 may be substantially the same since the output power range may be the same. Additionally, the integrated 2-in-1 tap photodiode assembly TPDA allows for sharing the same tap ratio filter. Similar benefits are provided for the second amplifier configuration 130, whereby an overall size of the optoelectronic device 400 is reduced.

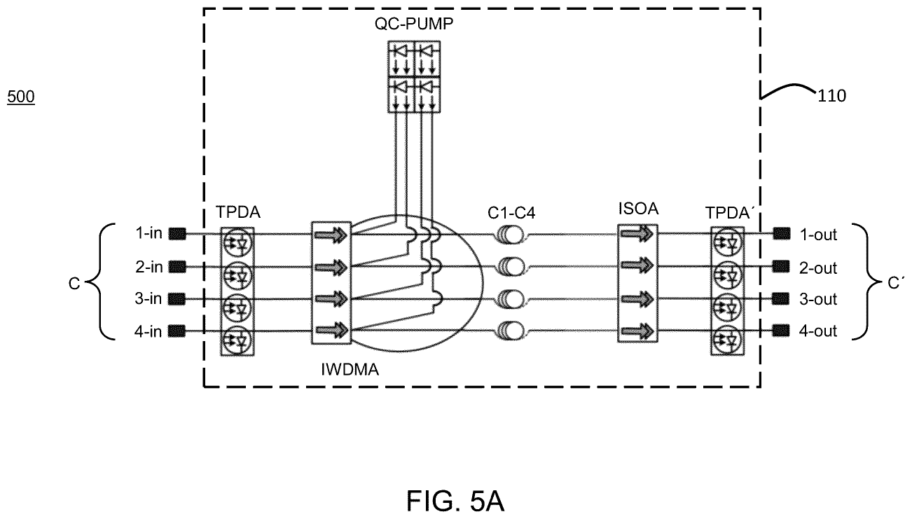

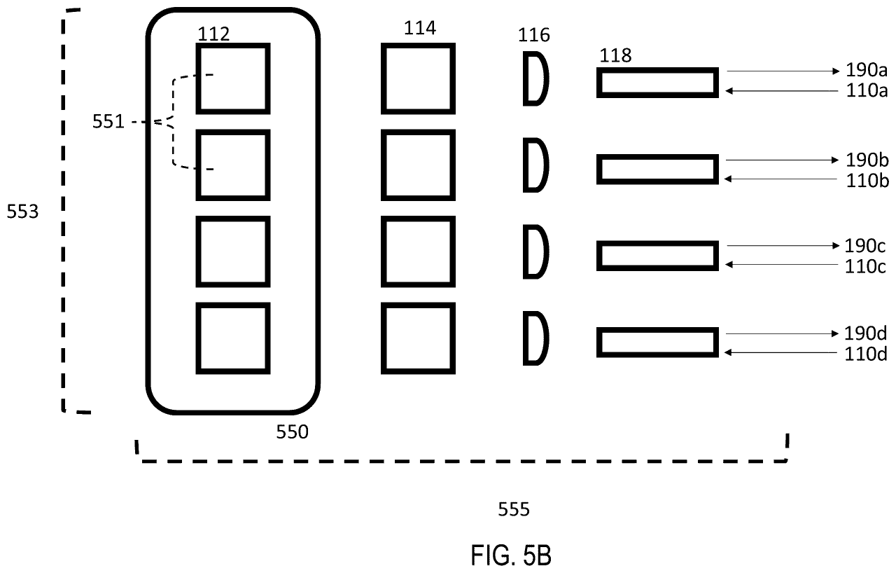

FIG. 5A is a schematic diagram illustrating another exemplary optical amplifier device 500 with a hybrid combination of optical components. In FIG. 5A, the optical amplifier device 500 includes a 4-input tap photodiode assembly TDPA, a 4-in-1 isolated wavelength division multiplexer assembly IWDMA, a 4-in-1 optical isolator assembly ISOA, a 4-input tap photodiode assembly TPDA′, and two dual-pump chips in a quad chip pump configuration QC-PUMP. In some implementations, the quad chip pump configuration QC-PUMP may comprise a pair of 3-pin dual chip pumps in a single package or a 6-pin quad chip pump in a single package. By implementing a hybrid combination of optical components, and overall size of the optical amplifier device 500 can be reduced and may afford an ability to incorporate additional optical elements.

Here, the erbium-doped fiber coils C1-C4 are provided individually to provide for separate amplification, and may be excluded from a grouped assembly in a manner similar to any of the 4-input tap photodiode assembly TDPA, the 4-in-1 isolated wavelength division multiplexer assembly IWDMA, the 4-in-1 optical isolator assembly ISOA, and the 4-input tap photodiode assembly TPDA′.

The input optical ports 1-in, 2-in, 3-in, and 4-in may comprise a connector C and the output optical ports 1-out, 2-out, 3-out, and 4-out may also comprise a connector C′, either the same or different from the connector C of the input optical ports 1-in, 2-in, 3-in, and 4-in.

In FIG. 5A, each of the 4-input tap photodiode assembly TDPA, the 4-in-1 isolated wavelength division multiplexer assembly IWDMA, the 4-in-1 optical isolator assembly ISOA, the 4-input tap photodiode assembly TPDA′, and the two dual-pump chips in the quad chip pump configuration QC-PUMP may be considered as combined optical components. These combined optical components provide similar functionality in a reduced form factor. This reduction in size leads to an overall reducing packaging size of the optical amplifier device 500. In particular, these combined similar optical components can reduce, both individually and in combination, an overall size of a package housing the optical amplifier device. Synergistic effects related to reducing packaging size can be realized by combining similar optical elements in groupings with respect to the optical amplifier device 500 depicted in FIG. 5A.

In the illustrated embodiment of FIG. 5A, an overall size of the optical amplifier device 500 is reduced compared to the optical amplifier device 100 depicted in FIG. 1. In particular, each of the 4-input tap photodiode assembly TDPA, the 4-in-1 isolated wavelength division multiplexer assembly IWDMA, the 4-in-1 optical isolator assembly ISOA, and the 4-input tap photodiode assembly TPDA′ individually contribute to reducing an overall size of the optical amplifier device 500.

FIG. 5B is a schematic illustration of a 4 in 1 Tap PD Array example, which may be, for example, the TPDA or TPDA′ of FIG. 5A. As shown, four sets of the previously discussed Tap PD design (FIG. 1C) are combined into a single optical package, although additional or fewer sets may also be used. In certain embodiments, the PD die 112 may be comprised of a 1×4 PD die array 550 or 4 discrete PD dies 112; the pitch between each channel 551 may be, for example, 250 μm, 500 μm, or 750 μm; the optical tap filter 114 may be comprised of a 1×4 tap filter array or 4 discrete tap filters 114; the lens component 116 may be a 1×4 lens array, or a set of 4 discrete lenses 116; the pigtail component 118 may be 4 discrete dual fiber heads 118, 2 four-channel fiber heads, or 1 eight-channel fiber head; and the dimensions of the Tap PD array 553, 555 may vary based on the components selected. In the illustrated embodiment, the PD component 112 is a 1×4 PD die array 550; the pitch between each channel 551 is 750 μm, to account for limitations on the size of the fiber head within the desired form factor; the optical tap filter component 114 is a set of 4 discrete tap filters 114; the lens component 116 is a set of 4 discrete lenses 116; the pigtail component 118 is a set of 4 discrete dual fiber heads 118; and the dimensions of the Tap PD array are 10 mm in length 555, 3 mm in height 553 and 1 mm in depth (into and out of the page).

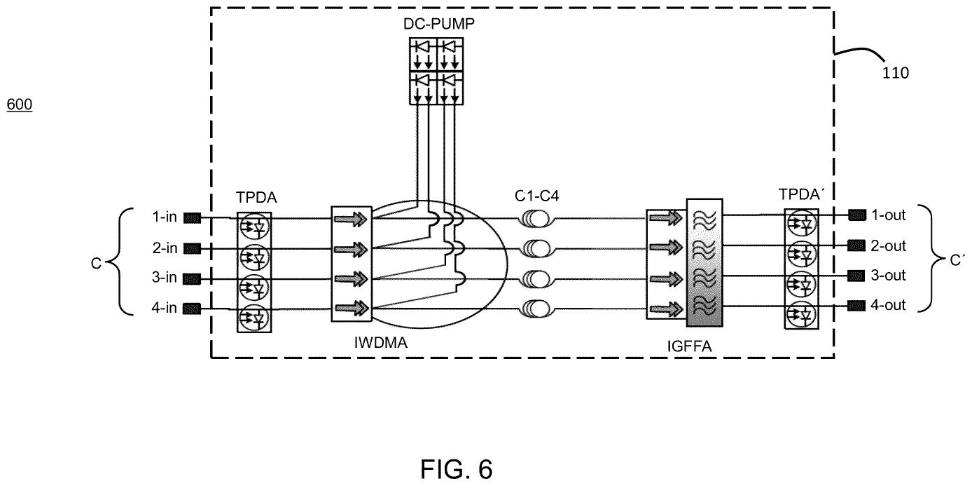

FIG. 6 is a schematic diagram illustrating another exemplary optical amplifier device 600 with both combined similar optical elements in groupings and a hybrid grouping of particular optical components. In FIG. 6, the optical amplifier device 600 includes four dual-amplifiers in a single packaging configuration and is similar to the optical amplifier device 500 depicted in FIG. 5A. However, in FIG. 6, each of the 4-in-1optical isolator assembly ISOA is replaced with a hybrid optical component comprising an isolator gain flattening filter assembly IGFFA. Accordingly, as described above with respect to FIG. 2A, implementing the isolator gain flattening filter assembly IGFFA improves gain flatness, suppresses amplifier spontaneous emission (ASE), and improves the performance of global optical signal to noise ratio (OSNR).

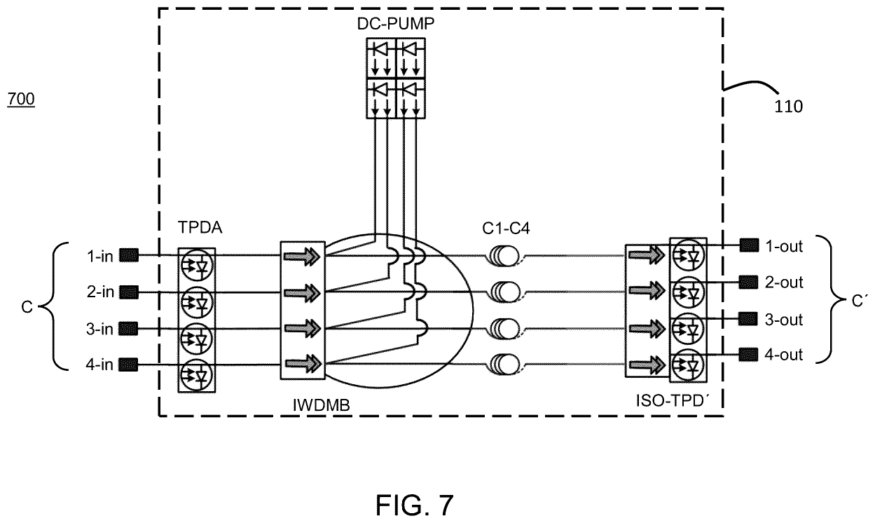

FIG. 7 is a schematic diagram illustrating another exemplary optical amplifier device with both combined similar optical elements in groupings and a hybrid grouping of particular optical components. Similar to the device 500 depicted in FIG. 5A, the optical amplifier device 700 of FIG. 7 includes four amplifiers in a single packaging configuration. However, in FIG. 7, the 4-in-1optical isolator assembly ISOA and the 4-in-1 tap photodiode assembly TPDA′ are replaced with a hybrid combination of optical components, comprising an integrated optical isolator and tap photodiode assembly ISO-TPD′. Accordingly, the overall size of the optical amplifier device 700 is reduced even further than the prior reductions.

In FIGS. 1A-7, pairs of dual-amplifiers (or quad amplifier) are contained within one QSFP, and with implementing hybrid combinations of optical components, the density of optical amplifiers and components increases compared to single optical amplifiers and individual optical components in one QSFP. For example, in FIGS. 2A-4, 6, and 7, the hybrid combination of optical components, such as the isolator gain flattening filter IGFF, the integrated optical isolator and tap photodiodes ISO-PDA, and the integrated tap photodiode assembly TPDA, are more compact than their counterpart individual elements. Accordingly, by implementing these hybrid combination of optical components in the exemplary optical amplifier devices, not only is the overall size of the optical amplifier devices reduced, but additional space is provided in order to implement additional optical components in the same package configuration. With respect to FIGS. 1A-7, the implementation of the hybrid components, such as those discussed above, can also realize an optical amplifier device using multiple amplifiers with tapered optical fibers (TOF), variable optical attenuation (VOA), optical supervisory channel (OSC), and other operational functions. Additionally, the implementation of hybrid components can also realize an optical amplifier device having a multi-channel, multi-stage amplification amplifier.

Additionally, with respect to FIGS. 1A-7, the implementation of hybrid combinations of optical components can significantly increase the density of other components of the optical amplifier devices in a same package configuration. That is, by reducing the need for certain optical parts and using others for multi-channel or multi-function through shared same optical parts between channels, the hybrid optical components can be individually reduced in size into a small tube, for example about less than or equal to 12 mm×1.2 mm (length×diameter), for example about less than or equal to 10 mm×0.7 mm (length×diameter)×0.7 mm in order to form a QSFP fit and implementation.

As disclosed herein, fitting quad amplifiers into a QSFP requires a reduction of the total volume of all the optical components and the fibers. Whether to use integrated optics or separate optics depends primarily on the overall volume of the device required to achieve the same optical function. For example, in designs having two EDFAs fit into a single QSFP package using a tap PD with a diameter of 1.8 mm and a length of 14 mm. The usage of two EDFAs corresponds to four tap PDs, and each EDFA has one input tap PD and one output tap PD. Correspondingly, four EDFAs require eight tap PDs. Disclosed herein, an example the size of the tap PD is less than 1.0 mm in diameter and 10 mm in length. In one example, a tap PD is reduced by replacing an outer glass tube with a thinner metal tube and having a reduced pigtail and lens size. The volume of one traditional tap PD with a diameter of 1.8*14 mm is 35.61 cubic millimeters, and the total volume of four tap PDs with a diameter of 1.8*14 mm is 142.4 cubic millimeters. Disclosed Tap PDs with a dimension of 1.0×10 mm (diameter×length), the volume of one Tap PD is 7.85 cubic millimeters (mm³), and the total volume of eight Tap PDs with a diameter of 1.0*10 mm is 62.8 cubic millimeters. Therefore, although the density of EDFAs increased from 2 to 4 channels and the number of tap PDs increased from 4 to 8, the overall volume did decrease from 142.4 cubic millimeters to 62.8 cubic millimeters comparatively. Therefore, the reduction of the size of a single device is one of the solutions to increase the density. In some embodiments using the smaller form Tap PD disclosed, a traditional assembly may be used, where the individual optics are assembled together onto a glass tube, which is coated with a metal tube and welded together. In some embodiments using the smaller form Tap PD disclosed, an assembly method with no metal tubing is used, with the components being bonded or nested together by glass tubes only.

In some implementations, other optical amplifiers can be used, such as the BA and the PA. For example, the optical amplifier devices can support two BA's and two PA's in a single packaging configuration, or multiple combinations of the BA's and PA's in a quad BA/PA packaging configuration. Moreover, the optical amplifier devices can support four BA's in a single quad-BA packaging configuration, or support four PA's in a single quad-PA packaging configuration.

Unless specific arrangements described herein are mutually exclusive with one another, the various implementations described herein can be combined in whole or in part to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An optical amplifier device, comprising:
a plurality of input optical ports, each being configured to receive one of a plurality of input optical signals;
a plurality of output optical ports, each being configured to output one of a plurality of output optical signals;
a plurality of tap photodiodes, each respectively being connected to one of the plurality of input optical ports and the plurality of output optical ports;
a wavelength division multiplexer configured to (i) receive the input optical signal from each of the plurality of input optical ports and an optical input from a laser pump device and (ii) output a plurality of pumped optical signals;
a plurality of erbium-doped fiber coils, each having a first end configured to receive one of the plurality of pumped optical signals and a second end configured to output an amplified optical signal; and
an optical isolator configured to (i) receive, for each of the plurality of erbium-doped fiber coils, the amplified optical signal and (ii) output the plurality of output optical signals,
wherein the plurality of output optical ports are configured to receive one of the plurality of output optical signals.

2. The optical amplifier device of claim 1, wherein the plurality of input optical ports are combined in a first optical connector and the plurality of output optical ports are combined in a second optical connector.

3. The optical amplifier device of claim 1, wherein the optical isolator comprises a hybrid optical component comprising the optical isolator and a gain flattening filter.

4. The optical amplifier device of claim 1, wherein the optical isolator and the plurality of tap photodiodes connected to the plurality of output optical ports comprise an integrated hybrid optical component configured to receive the amplified optical signal and output the plurality of output optical signals.

5. The optical amplifier device of claim 1, wherein the plurality of tap photodiodes connected to the plurality of input optical ports comprise a first tap photodiode assembly configured to receive the plurality of input optical signals received by the plurality of input optical ports.

6. The optical amplifier device of claim 5, wherein the plurality of tap photodiodes connected to the plurality of output optical ports comprise a second tap photodiode assembly configured to receive the plurality of output optical signals.

7. The optical amplifier device of claim 1, wherein the laser pump device comprises one of a dual-core laser pump and a quad-core laser pump.

8. The optical amplifier device of claim 1, wherein the plurality of erbium-doped fiber coils are configured individually to be excluded from a grouped assembly.

9. An optical amplifier system comprising more than one of the optical amplifier device of claim 1.

10. The optical amplifier system of claim 9, wherein, for the more than one of the optical amplifier device, each of the plurality of input optical ports are combined in a first optical connector and each of the plurality of output optical ports are combined in a second optical connector.

11. An optical amplifier system, comprising:
a plurality of input optical ports, each being configured in a first optical connector to receive one of a plurality of input optical signals;
a plurality of output optical ports, each being configured in a second optical connector to output one of a plurality of output optical signals;
a plurality of first tap photodiodes, each being connected to one of the plurality of input optical ports;
a wavelength division multiplexer configured to (i) receive the plurality of input optical signals from each of the plurality of input optical ports and an optical input from a laser pump device and (ii) output a plurality of pumped optical signals;
a plurality of erbium-doped fiber coils, each having a first end configured to receive one of the plurality of pumped optical signals and a second end configured to output one of a plurality of amplified optical signals;
a plurality of optical isolators, each configured to (i) receive the plurality of amplified optical signal and (ii) output the plurality of output optical signals; and
a second plurality of tap photodiodes, each of the second plurality of tap photodiodes being connected to one of the plurality of output optical ports.

12. The optical amplifier system of claim 11, wherein each of the plurality of optical isolators is configured in a third assembly to receive the plurality of amplified optical signals and output the plurality of output optical signals.

13. The optical amplifier system of claim 11, wherein each of the plurality of optical isolators comprises a hybrid optical component assembly comprising the plurality of optical isolators and a plurality of gain flattening filters.

14. The optical amplifier system of claim 11, wherein each of the plurality of optical isolators comprises a hybrid optical component assembly comprising the plurality of optical isolators and the second plurality of tap photodiodes.

15. The optical amplifier system of claim 11, wherein the plurality of erbium-doped fiber coils are configured individually to be excluded from a grouped assembly.

16. The optical amplifier system of claim 11, wherein the laser pump device comprises a quad-core laser pump.

17. An optical amplifier assembly, comprising:
a first optical connector comprising a plurality of input optical ports, each being configured to receive one of a plurality of input optical signals;
a second connector comprising a plurality of output optical ports, each being configured to output one of a plurality of output optical signals;
a first tap photodiode assembly comprising a plurality of first tap photodiodes, each being connected to one of the plurality of input optical ports;
a wavelength division multiplexer configured to (i) receive the plurality of input optical signals from each of the plurality of input optical ports and an optical input from a laser pump device and (ii) output a plurality of pumped optical signals;
a plurality of erbium-doped fiber coils, each having a first end configured to receive one of the plurality of pumped optical signals and a second end configured to output one of a plurality of amplified optical signals;
an optical isolator assembly comprising a plurality of optical isolators, each configured to (i) receive the plurality of amplified optical signal and (ii) output the plurality of output optical signals; and
a second tap photodiode assembly comprising a plurality of second tap photodiodes, each being connected to one of the plurality of output optical ports.

18. The optical amplifier assembly of claim 17, wherein the plurality of erbium-doped fiber coils are configured individually to be excluded from a grouped assembly.

19. The optical amplifier assembly of claim 17, wherein the laser pump device comprises a quad-core laser pump.

20. The optical amplifier assembly of claim 17, wherein one of:
the optical isolator assembly comprises a hybrid optical component assembly comprising the plurality of optical isolators and a plurality of gain flattening filters; and
the optical isolator assembly and the second tap photodiode assembly comprise a hybrid optical component assembly comprising the plurality of optical isolators and the plurality of second tap photodiodes.
